(19) United States
(12) Patent Application Publication
(10) Pub. No.: US 2013/0325475 A1
(43) Pub. Date: Dec. 5, 2013

(54) APPARATUS AND METHOD FOR DETECTING END POINT USING DECODING INFORMATION

(71) Applicant: ELECTRONICS AND TELECOMMUNICATIONS RESEARCH INSTITUTE, (US)

(72) Inventors: Hoon Chung, Hongcheon (KR); Ki-Young Park, Daejeon (KR); Sung-Joo Lee, Daejeon (KR); Yun-Keun Lee, Daejeon (KR)

(73) Assignee: ELECTRONICS AND TELECOMMUNICATIONS RESEARCH INSTITUTE, Daejeon-city (KR)

(21) Appl. No.: 13/870,409

(22) Filed: Apr. 25, 2013

(30) Foreign Application Priority Data
May 31, 2012 (KR) 10-2012-0058249

(51) Int. Cl. G10L 15/05

(52) U.S. Cl. CPC G10L 15/05
USPC 704/253

(57) ABSTRACT

An apparatus for detecting an end point using decoding information includes: an end point detector configured to extract a speech signal from an acoustic signal received from outside and detect end points of the speech signal; a decoder configured to decode the speech signal; and an end point detector configured to extract reference information serving as a standard of actual end point discrimination from decoding information generated during the decoding process of the decoder, and discriminate an actual end point among the end points detected by the end point detector based on the extracted reference information.

### CROSS-REFERENCE(S) TO RELATED APPLICATIONS

This application claims priority to Korean Patent Application No. 10-2012-0058249 filed on May 31, 2012 which is incorporated herein by reference in its entirety.

### BACKGROUND OF THE INVENTION

1. Field of the Invention

Exemplary embodiments of the present invention relate to an apparatus and method for detecting an end point using decoding information; and, particularly, to an apparatus and method for detecting an end point using decoding information, which is capable of improving speech recognition performance.

2. Description of Related Art

Conventionally, an end point detector for detecting a speech section includes a decoder and an end point detector which are separated from each other in order to independently operate.

In general, the end point detector measures energy for each frame from an input signal, considers the frame as a speech section when the energy exceeds a predefined value, and considers the frame as a non-speech section when the energy does not exceed the predetermined value. In this case, most of the end point detectors check whether or not a silent section continues for a predetermined time, in order to determine whether or not speaking was completed. That is, the end point detectors determine that the speaking was completed when the silent section continues during the defined period. Otherwise, the end point detectors wait for an additional voice input.

However, when the conventional end point detector is used to perform speech recognition, a silent section between words may increase in the case of a user such as a child or elderly person who is not accustomed to using a speech recognition system. In this case, when the silent section between words increases, the end point detector may cause an error indicating that the speaking was ended even though the speaking is not completed.

For example, Korean Patent Laid-open Publication No. 10-2009-0123396 discloses a system for robust voice activity detection and continuous speech recognition in a noisy environment using real-time calling key-word recognition. When a speaker speaks a call command, the system recognizes the call command, measures reliability, and applies speech sections, which are continuously spoken after the call command, to a continuous speech recognition engine, in order to recognize the speech of the speaker. The system requires a lot of time and cost for previously selecting a call command and constructing a recognition network, in order to perform speech recognition.

### SUMMARY OF THE INVENTION

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with an embodiment of the present invention, an apparatus for detecting an end point using decoding information includes: an end point detector configured to extract a speech signal from an acoustic signal received from outside and detect end points of the speech signal; a decoder configured to decode the speech signal; and an end point detector configured to extract reference information serving as a standard of actual end point discrimination from decoding information generated during the decoding process of the decoder, and discriminate an actual end point among the end points detected by the end point detector based on the extracted reference information.

The decoder may generate decoding information including one or more of the number of end point detections of a continuous sentence, an average phoneme duration, a phoneme duration standard deviation, a maximum phoneme duration, and a minimum phoneme duration.

The end point discriminator may discriminate whether or not the detected end point corresponds to a silent section occurring after speaking is ended, based on the reference information. When the detected end point corresponds to a silent section occurring after the speaking is ended, the end point discriminator may determine that the detected end point is an actual end point.

The end point discriminator may discriminate whether or not the detected end point corresponds to a silent section occurring between words, based on the reference information. When the detected end point corresponds to a silent section occurring between words, the end point discriminator may determine that the detected end point is not an actual end point.

The end point discriminator may include a feature extraction unit configured to extract reference information including one or more of the number of end point detections of a continuous sentence, an average phoneme duration, a phoneme duration standard deviation, a maximum phoneme duration, and a minimum phoneme duration, from the decoding information.

The end point discriminator may further include a discrimination unit configured to discriminate whether the detected end point is an actual end point or not, based on the extracted reference information.

The end point discriminator may further include a storage unit configured to store the extracted reference information.

In accordance with another embodiment of the present invention, a method for detecting an end point using decoding information includes extracting, by an end point detector, a speech signal from an acoustic signal received from outside, and detecting end points of the speech signal; decoding, by a decoder, the speech signal; extracting, by an end point discriminator, reference information serving as a standard for actual end point discrimination from decoding information generated during the decoding process of the decoder; and discriminating, by the end point discriminator, an actual end point among the detected end points, based on the reference information.

In decoding the speech signal, the decoder may generate the decoding information including one or more of the number of end point detections of a continuous sentence, an average phoneme duration, a phoneme duration standard deviation, a maximum phoneme duration, and a minimum phoneme duration, from the decoding information.

In extracting the reference information serving as a standard for actual end point discrimination from the decoding information generated during the decoding process of the decoder, the end point discriminator may extract the reference information including one or more of the number of end point detections of a continuous sentence, an average phoneme duration, a phoneme duration standard deviation, a maximum phoneme duration, and a minimum phoneme duration, from the decoding information.

Discriminating the actual end point among the detected end points, based on the reference information, may include: detecting whether or not the detected end point corresponds to a silent section occurring after speaking is ended, based on the reference information; and determining that the detected end point is an actual end point, when the detected end point corresponds to a silent section occurring after the speaking is ended.

Discriminating the actual end point among the detected end points, based on the reference information, may include: detecting whether or not the detected end point corresponds to a silent section occurring between words, based on the reference information; and determining that the detected end point is not an actual end point, when the detected end point corresponds to a silent section occurring between words.

### BRIEF DESCRIPTION OF THE DRAWINGS

FIG. 1 is a diagram illustrating the configuration of an apparatus for detecting an end point using decoding information in accordance with an embodiment of the present invention.

FIG. 2 is a configuration illustrating the detailed configuration of an end point discriminator employed in the apparatus for detecting an end point using decoding information in accordance with the embodiment of the present invention.

FIG. 3 is a flow chart showing the method for detecting an end point using decoding information in accordance with the embodiment of the present invention.

### DESCRIPTION OF SPECIFIC EMBODIMENTS

Exemplary embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art. Throughout the disclosure, like reference numerals refer to like parts throughout the various figures and embodiments of the present invention.

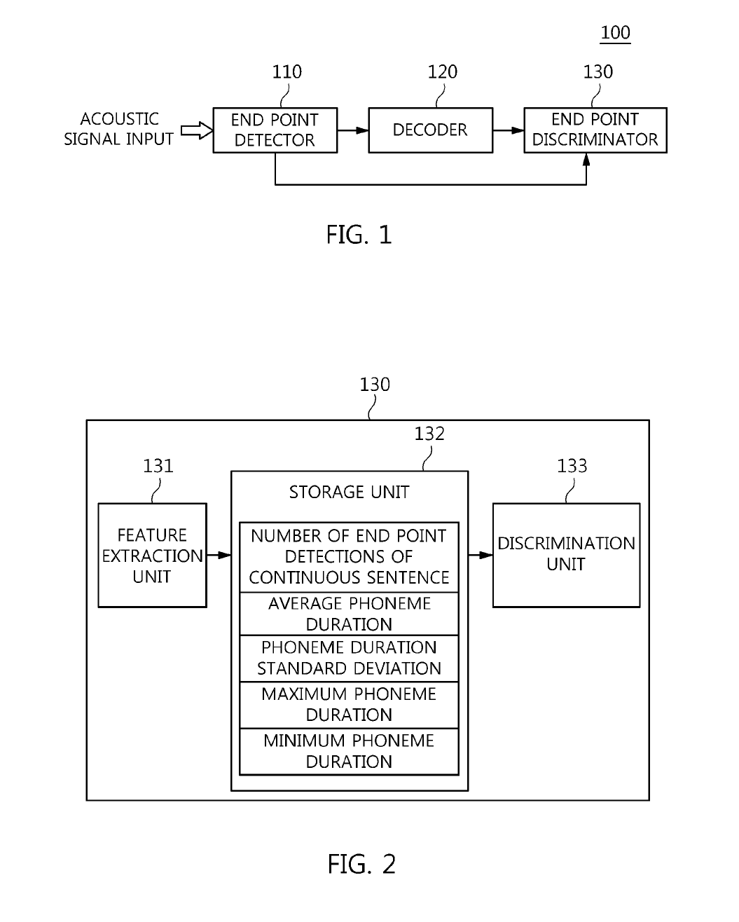

Hereafter, an apparatus for detecting an end point using decoding information in accordance with an embodiment of the present invention will be described in detail with reference to the accompanying drawings. FIG. 1 is a diagram illustrating the configuration of the apparatus for detecting an end point using decoding information in accordance with the embodiment of the present invention. FIG. 2 is a configuration illustrating the detailed configuration of an end point discriminator employed in the apparatus for detecting an end point using decoding information in accordance with the embodiment of the present invention.

Referring to FIG. 1, the apparatus for detecting an end point using decoding information in accordance with the embodiment of the present invention includes an end point detector 110, a decoder 120, and an end point discriminator 130.

The end point detector 110 is configured to receive an acoustic signal from outside and detect end points of a speech signal contained in the acoustic signal. In this case, the end point detector 110 detects the start and end points of the acoustic signal according to end point detection (EPD). Furthermore, the end point detector 110 detects the end points of the speech signal contained in the received acoustic signal using the energy and entropy-based characteristics of a time-frequency region of the acoustic signal, uses a voiced speech frame ratio (VSFR) to determine whether the acoustic signal is a voiced speech or not, and provides speech marking information indicating the start and end points of the speech.

The VSFR indicates the ratio of the entire speed frame to a voiced speech frame. The human speaking necessarily contains a voiced speech for a predetermined period or more. Therefore, such a characteristic may be used to easily discriminate a speech section and a non-speech section of the input acoustic signal.

The decoder 120 is configured to decode a speech signal. In this case, the decoder 120 generates decoding information including one or more of the number of end point detections of a continuous sentence, an average phoneme duration, a phoneme duration standard deviation, a maximum phoneme duration, and a minimum phoneme duration, through whether or not the decoding reaches a terminal node of a search space and whether or not the phonemes consume the speech frame. The result obtained by detecting the end point using the decoding information includes a long silent section between words and a short silent section after the speaking is ended. That is, when the decoding information is used, the silent section between words may be maintained in a long manner, and the silent section after the end of the speaking may be immediately detected.

The end point discriminator 130 is configured to extract reference information serving as the standard of actual end point detection from the decoding information received from the decoder 120, and discriminate an actual end point among the end points detected by the end point detector 110 based on the extracted reference information. In this case, the end point discriminator 130 may be configured by combining the decoder and the end point detector, and may extract the reference information for end point detection using the end point detector based on the decoding information of the decoder.

For this operation, the end point discriminator 130 includes a feature extraction unit 131, a storage unit 132, and a discrimination unit 133, as illustrated in FIG. 2.

The feature extraction unit 131 is configured to extract the reference information serving as a standard of the end point discrimination from the decoding information received from the decoder 120. That is, the feature extraction unit 131 extracts the reference information including one or more of the number of end point detections of a continuous sentence, an average phoneme duration, a phoneme duration standard deviation, a maximum phoneme duration, and a minimum phoneme duration, from the decoding information.

The respective pieces of basic information extracted in such a manner have the following meanings.

The number of end point detections of a continuous sentence refers to information used to detect whether speaking was ended or not. That is, the decoding needs to reach an end node of the sentence in a search space for recognition, which is searched by the decoder 120, in order to detect that the speaking was ended. Therefore, when the end node of the sentence is continuously detected, the speaking may be considered to be ended.

The average phoneme duration refers to an average time occupied by phonemes forming a sentence with respect to an input speech signal.

The phoneme duration standard deviation refers to a standard deviation of times occupied by the phonemes forming the sentence with respect to the input speech signal.

The maximum phoneme duration refers to a time of a phoneme occupying the maximum time among the phonemes.

The minimum phoneme duration refers to a time of a phoneme occupying the minimum time among the phonemes.

The storage unit 132 is configured to store the basic information extracted from the feature extraction unit 131.

The discrimination unit 133 is configured to determine whether the detected end point is an end point caused by a silent section between words or an end point caused by a silent section caused after the speaking is ended, and discriminate an actual end point among the end points detected by the end point detector 110. The discrimination unit 133 applies determination logic to determine whether the end point detection result is wrong or right. In this case, the determination logic may include a method of comparing a critical value and a boundary value of an extracted feature, a Gaussian mixture model (GMM) method using a statistical model, a multi-layer perception (MLP) method using artificial intelligence, a classification and regression tree (CART) method, a likelihood ratio test (LRT) method, a support vector machine (SVM) method and the like.

The discrimination unit 133 detects whether or not the detected end point corresponds to a silent section occurring after the end of the speaking, based on the reference information. When the detected end point corresponds to a silent section occurring after the end of the speaking, the discrimination unit 133 determines that the detected end point is an actual end point. Meanwhile, the discrimination unit 133 detects whether or not the detected end point corresponds to a silent section occurring between words. When the detected end point corresponds to a silent section occurring between words, the discrimination unit 133 determines that the detected end point is not an actual end point.

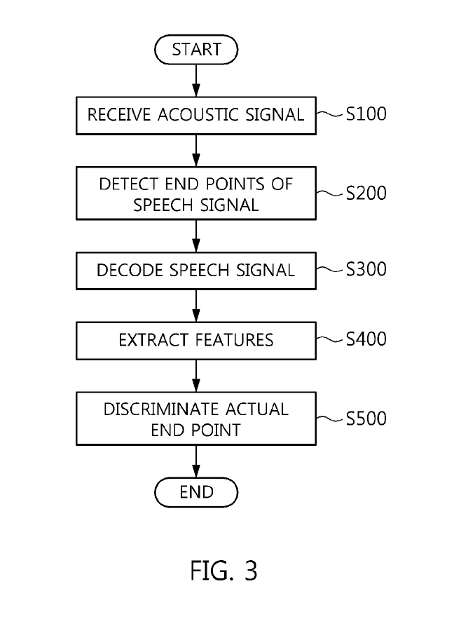

Hereafter, a method for detecting an end point using decoding information in accordance with the embodiment of the present invention will be described below in detail with reference to the accompanying drawings. FIG. 3 is a flow chart showing the method for detecting an end point using decoding information in accordance with the embodiment of the present invention.

Referring to FIG. 3, the end point detector 110 first receives an acoustic signal containing speech and noise from outside at step S100.

Then, the end point detector 110 detects end points of a speech signal contained in the acoustic signal at step S200. In this case, the end point detector 110 detects the start and end points of the acoustic signal contained in the acoustic signal according to the EPD.

Then, the decoder 120 decodes the speech signal and generates decoding information at step S300. In this case, the decoder 120 generates the decoding information including one or more of the number of end point detections of a continuous sentence, an average phoneme duration, a phoneme duration standard deviation, a maximum phoneme duration, and a minimum phoneme duration, through whether or not the decoding reaches a terminal node of a search space and whether or not phonemes consume the speech frame.

Then, the end point discriminator 130 extracts reference information serving as a standard of actual end point discrimination from the decoding information at step S400. In this case, the end point discriminator 130 extracts the reference information including one or more of the number of end point detections of a continuous sentence, an average phoneme duration, a phoneme duration standard deviation, a maximum phoneme duration, and a minimum phoneme duration.

Then, the end point discriminator 130 discriminates an actual end point among the end points detected by the end point detector 110, based on the extracted reference information, at step S500. In this case, the end point discriminator 130 detects whether or not the detected end point corresponds to a silent section occurring after the end of the speaking, based on the reference information. When the detected end point corresponds to a silent section occurring after the end of the speaking, the discrimination unit 133 determines that the detected end point is an actual end point. Meanwhile, the discrimination unit 133 detects whether or not the detected end point corresponds to a silent section occurring between words. When the detected end point corresponds to a silent section occurring between words, the discrimination unit 133 determines that the detected end point is not an actual end point.

Finally, when the end point discriminator 130 determines that the end point detected by the end point detector is the actual end point, the speech recognition is ended under the supposition that the speaking was ended.

As such, the apparatus and method for detecting an end point using decoding information in accordance with the embodiment of the present invention discriminates the silent section occurring between words and the silent section occurring after the end of the speech, using the information of the decoder. Accordingly, the apparatus and method may allow the silent section occurring between words as much as possible, and minimize the silent section occurring after the end of the speaking, thereby improving the speech recognition speed.

While the present invention has been described with respect to the specific embodiments, it will be apparent to those skilled in the art that various changes and modifications may be made without departing from the spirit and scope of the invention as defined in the following claims.

What is claimed is:

1. An apparatus for detecting an end point using decoding information, comprising:
an end point detector configured to extract a speech signal from an acoustic signal received from outside and detect end points of the speech signal;
a decoder configured to decode the speech signal; and
an end point detector configured to extract reference information serving as a standard of actual end point discrimination from decoding information generated during the decoding process of the decoder, and discriminate an actual end point among the end points detected by the end point detector based on the extracted reference information.

2. The apparatus of claim 1, wherein the decoder generates decoding information comprising one or more of the number of end point detections of a continuous sentence, an average phoneme duration, a phoneme duration standard deviation, a maximum phoneme duration, and a minimum phoneme duration.

3. The apparatus of claim 1, wherein the end point discriminator discriminates whether or not the detected end point corresponds to a silent section occurring after speaking is ended, based on the reference information, and when the detected end point corresponds to a silent section occurring after the speaking is ended, the end point discriminator determines that the detected end point is the actual end point.

4. The apparatus of claim 1, wherein the end point discriminator discriminates whether or not the detected end point corresponds to a silent section occurring between words, based on the reference information, and when the detected end point corresponds to a silent section occurring between words, the end point discriminator determines that the detected end point is not the actual end point.

5. The apparatus of claim 1, wherein the end point discriminator comprises a feature extraction unit configured to extract reference information comprising one or more of the number of end point detections of a continuous sentence, an average phoneme duration, a phoneme duration standard deviation, a maximum phoneme duration, and a minimum phoneme duration, from the decoding information.

6. The apparatus of claim 5, wherein the end point discriminator further comprises a discrimination unit configured to discriminate whether the detected end point is the actual end point or not, based on the extracted reference information.

7. The apparatus of claim 5, wherein the end point discriminator further comprises a storage unit configured to store the extracted reference information.

8. A method for detecting an end point using decoding information, comprising:
extracting, by an end point detector, a speech signal from an acoustic signal received from outside, and detecting end points of the speech signal;
decoding, by a decoder, the speech signal;
extracting, by an end point discriminator, reference information serving as a standard for actual end point discrimination from decoding information generated during the decoding process of the decoder; and
discriminating, by the end point discriminator, an actual end point among the detected end points, based on the reference information.

9. The method of claim 8, wherein, in the decoding, by the decoder, the speech signal,
the decoder generates the decoding information comprising one or more of the number of end point detections of a continuous sentence, an average phoneme duration, a phoneme duration standard deviation, a maximum phoneme duration, and a minimum phoneme duration, from the decoding information.

10. The method of claim 8, wherein, in the extracting, by the end point discriminator, reference information serving as a standard for actual end point discrimination from decoding information generated during the decoding process of the decoder,
the end point discriminator extracts the reference information comprising one or more of the number of end point detections of a continuous sentence, an average phoneme duration, a phoneme duration standard deviation, a maximum phoneme duration, and a minimum phoneme duration, from the decoding information.

11. The method of claim 8, wherein the discriminating, by the end point discriminator, the actual end point among the detected end points, based on the reference information comprises:
detecting whether or not the detected end point corresponds to a silent section occurring after speaking is ended, based on the reference information; and
determining that the detected end point is the actual end point, when the detected end point corresponds to a silent section occurring after the speaking is ended.

12. The method of claim 8, wherein the discriminating, by the end point discriminator, the actual end point among the detected end points, based on the reference information, comprises:
detecting whether or not the detected end point corresponds to a silent section occurring between words, based on the reference information; and
determining that the detected end point is not the actual end point, when the detected end point corresponds to a silent section occurring between words.
